(19) United States
(12) Patent Application Publication
(10) Pub. No.: US 2019/0197749 A1
(43) Pub. Date: Jun. 27, 2019

(54) Method of Displaying Object Temperature

(71) Applicants: PO-WEN WANG, New Taipei City (TW); LEAPSY International Ltd., New Taipei City (TW)

(72) Inventor: PO-WEN WANG, New Taipei City (TW)

(21) Appl. No.: 15/910,014

(22) Filed: Mar. 2, 2018

(30) Foreign Application Priority Data
Dec. 27, 2017 (TW) 106146110

(51) Int. Cl. G06T 11/60; H04N 5/33; G06T 3/40

(52) U.S. Cl. CPC G06T 11/60; G01J 2005/0085; G06T 3/40; H04N 5/33

(57) ABSTRACT

A method of displaying an object temperature includes capturing an image and a thermal image; presetting a basis temperature; calculating temperature value of each point of the thermal image; comparing the temperature value with the basis temperature; displaying the temperature value exceeding the basis temperature.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

### Field of Invention

The invention relates to a method of displaying a temperature of an object.

### Description of Related Arts

Conventional temperature measuring devices include typical thermometer, infrared thermometer and thermal lens. In these devices, the typical thermometer responses very slow and must contacts human's body. The infrared thermometer can measure only a point. The thermal lens can measure a predetermined view angle range.

### SUMMARY OF THE PRESENT INVENTION

An object of the invention is to provide a method of displaying a temperature of an object. An image and a thermal image of a real scene are captured, and a basis temperature is preset. The thermal image is calculated to obtain a temperature value for each point of the thermal image. The temperature value exceeding the basis temperature and the image of the real scene are displayed on the display unit.

The invention also provides a method for displaying a temperature value. The method of the invention includes the following steps: providing a wearable device comprising an image capturing unit, a thermal sensing device and a display unit, wherein a basis temperature is preset; capturing an image through the image capturing device; capturing a thermal image through the thermal sensing device; regulating the thermal image to a size identical to a size of the image through a scaling algorithm; overlapping the thermal image to the image through an image overlapping algorithm; calculating a value of a temperature for each point of the thermal image through a temperature calculation algorithm; displaying a value of the temperature exceeding the basis temperature, illustrating the value of the temperature on the position wherein the temperature occurs and illustrating the overlapped image; regulating the thermal image to a size identical to a real scene through a scaling algorithm; overlapping the thermal image to the real scene through an image overlapping algorithm; removing the thermal image; and displaying the value of the temperature on the display unit.

A temperature of a person or an object exceeding a basis temperature is measured and displayed in a real time through the method of the invention. The method of the invention can be applied to quarantine, fire accident preventing or industry.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a block diagram of a wearable device capable of displaying an object temperature utilizing a method of the invention; and

FIG. 2 is a flow chart of an embodiment of a method for displaying an object temperature of the invention.

### DETAILED DESCRIPTION OF THE PREFERRED EMBODIMENT

The following description is of the best-contemplated mode of carrying out the invention. This description is made for the purpose of illustrating the general principles of the invention and should not be taken in a limiting sense. The scope of the invention is best determined by reference to the appended claims.

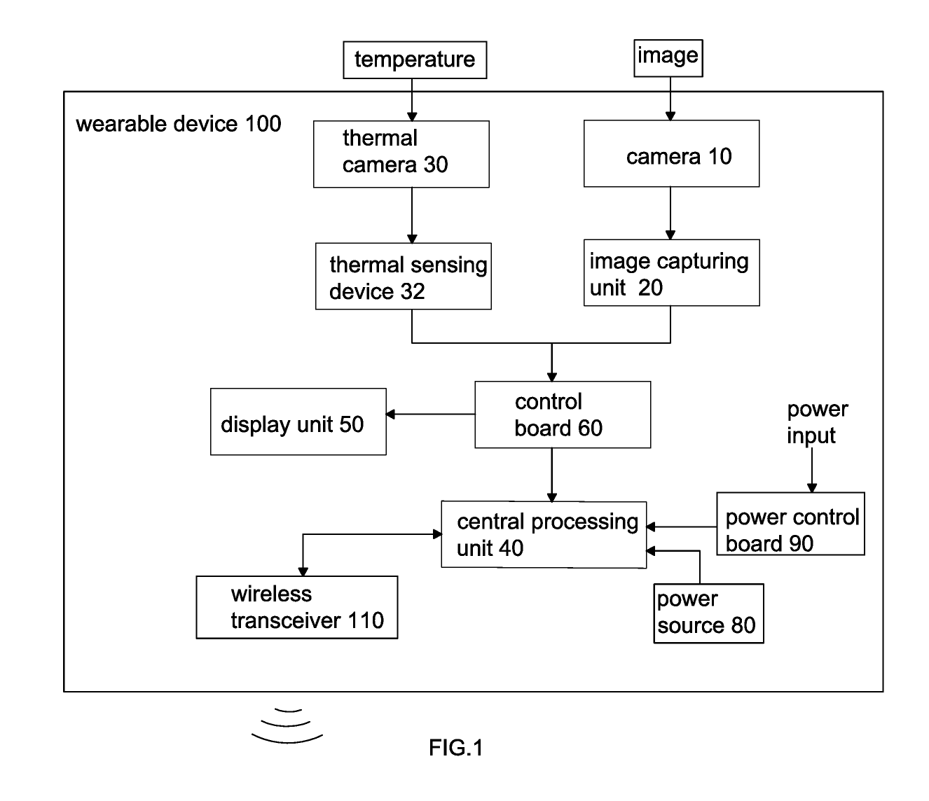

Referring to FIG. 1, a wearable device 100 capable of displaying a temperature of an object of the invention includes a camera 10, an image capturing unit 20, a thermal camera 30, a thermal sensing device 32, a central processing unit 40 and a display unit 50. The camera 10 is configured to receive external light to form an image. The image capturing unit 20 is configured to capture the image. In this embodiment, the image capturing unit 20 is a charge-coupled device (CCD) or complementary metal-oxide-semiconductor (CMOS) photo-sensing element. The central processing unit 40 is configured to receive the image. The thermal camera 30 receives the external light to form a thermal image. The thermal sensing device 32 is configured to receive the thermal image to generate temperature information. A user can preset a basis temperature. The central processing unit 40 is configured to receive the image and the thermal image, overlaps the image and the thermal image, calculates the temperature for each point of the thermal image and compares the calculated temperature with the basis temperature. The display unit 50 is connected to the central processing unit 40. The central processing unit 40 transmits the value of the temperature to the display unit 50 to display the value of the temperature exceeding the basis temperature. In this embodiment, the display unit 50 is a transparent display device. A user can see a real scene through the display unit 50. The temperature value is shown on display device 50 and located in a position where the temperature occurs in the real scene to be viewed by the user.

In addition, the wearable device 100 of the invention further includes a control board 60 through which the image and the thermal image are transmitted to the central processing unit 40. The control board 60 drives the image capturing unit 20 and the thermal sensing device 32.

The wearable device 100 of the invention further includes a power source 80 connected to the central processing unit 40. In this embodiment, the power source 80 is a battery. In another embodiment, the wearable device 100 of the invention further includes a power control board 90 coupled to the central processing unit 40. An external power source provides power for the wearable device 100 or charges the power source 80 through the power control board 90.

The wearable device 100 of the invention further includes a wireless transceiver 110 connected to the central processing unit 40. The central processing unit 40 transmits the value of the temperature to a control system through the wireless transceiver 110.

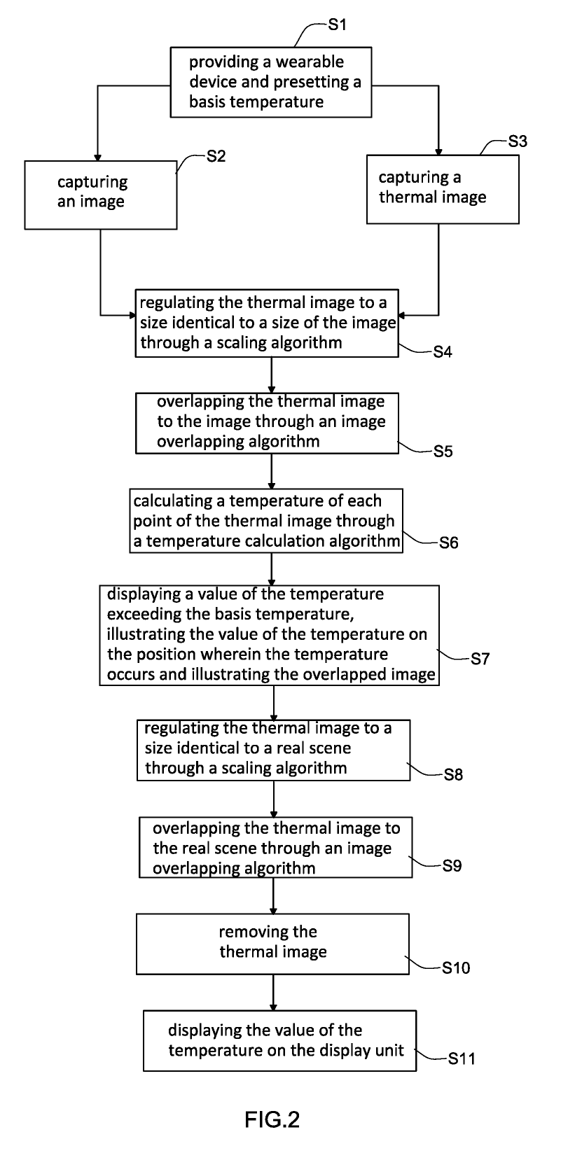

Referring to FIG. 2, an embodiment of a method for displaying an object temperature of the invention is disclosed. In a step S1, a wearable device is provided. The wearable device includes an image capturing device, a thermal sensing device and a display unit, and a basis temperature can be preset by a user in the wearable device 100. The procedure enters a step S2. In the step S2, an image is captured through the image capturing device. The procedure enters a step S3. In the step S3, a thermal image is captured through the thermal sensing device. The procedure enters a step S4. In the step S4, the thermal image is regulated to a size identical to a size of the image through a scaling algorithm. The procedure enters a step S5. In the step S5, the thermal image is overlapped to the image through an image overlapping algorithm. The procedure enters a step S6. In the step S6, a value of the temperature in the thermal image is calculated through a temperature calculation algorithm. The procedure enters a step S7. In the step S7, the value of the temperature is compared with the basis temperature and the value of the temperature exceeding the basis temperature is illustrated on the position where he temperature occurs. The procedure enters a step S8. In the step S8, the thermal image is regulated to a size identical to a real scene through a scaling algorithm. The procedure enters a step S9. In the step S9, the thermal image is overlapped to the real scene through an image overlapping algorithm. The procedure enters a step S10. In the step S10, the thermal image is removed, but the value of the temperature and the real scene are remained. The procedure enters a step S11. In the step S11, the value of the temperature is displayed on the display unit.

A temperature of a thermal image is measured and displayed in a real time through the method of the invention. The method of the invention can be applied to quarantine, fire accident preventing or industry.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for displaying a temperature of an object, comprising:
providing a wearable device comprising an image capturing device, a thermal sensing device and a display unit, wherein a basis temperature can be preset;
capturing an image through the image capturing device;
capturing a thermal image through the thermal sensing device;
regulating the thermal image to a size identical to a size of the image through a scaling algorithm;
overlapping the thermal image to the image through an image overlapping algorithm;
calculating a temperature of each point of the thermal image through a temperature calculation algorithm;
displaying a value of the temperature exceeding the basis temperature, illustrating the value of the temperature on the position wherein the temperature occurs and illustrating the overlapped image;
regulating the thermal image to a size identical to a real scene through a scaling algorithm;
overlapping the thermal image to the real scene through an image overlapping algorithm;
removing the thermal image; and
displaying the value of the temperature on the display unit.
